(19) United States
(12) Patent Application Publication
(10) Pub. No.: US 2012/0137395 A1
(43) Pub. Date: May 31, 2012

(54) SCANNED PROBE MICROSCOPE WITHOUT INTERFERENCE OR GEOMETRIC CONSTRAINT FOR SINGLE OR MULTIPLE PROBE OPERATION IN AIR OR LIQUID

(75) Inventors: Aaron Lewis, Jerusalem (IL); David Lewis, Jerusalem (IL); Rima Dekhter, Jerusalem (IL); Galina Fish, Modiin (IL); Michael Kokotov, Rehovot (IL); Sofia Kokotov, Maale Adumim (IL); Oleg Fedosyeyev, Mevaseret Zion (IL); Anatoly Komissar, Ha Yerushalmit (IL)

(73) Assignee: NANONICS IMAGING LTD., Jerusalem (IL)

(21) Appl. No.: 13/254,167

(22) PCT Filed: Feb. 25, 2010
(86) PCT No.: PCT/US2010/025388

§ 371 Date: Feb. 21, 2012

(30) Foreign Application Priority Data
Mar. 1, 2009 (IL) 197329

(51) Int. Cl. G01Q 20/02; G01Q 20/00

(52) U.S. Cl. 850/6; 850/5

(57) ABSTRACT

A method and a device permit scanned probe microscopes with a non-optical feedback mechanism (1.2), such as a tuning fork, to be used in air or in liquid. The embodiments of the invention require geometric construction of the scanning device that can incorporate the non-optical feedback mechanism in a way that does not obstruct geometrically essentially any lens (1.3) from above or below and permits free access to the probe that is interacting with the sample. In one such embodiment, a scanner (1.1) in x, y and z can move the probe with a structure in which either the non-optical feedback mechanism is in the liquid or in the air and can use either a cantilevered or straight probe. The system can also be constructed with multiple independent scanned probe microscopy probes that can work in liquid and/or in air.

### BACKGROUND OF THE INVENTION

1. Field of the Invention

The present invention is a device and a method for allowing for a scanned probe microscope with operation in liquid or air using a design that does not obstruct either geometrically or optically or both the integration of such a device into other microscope systems such as upright optical microscopes. It also permits the use in liquids using a feedback mechanism without optical interference that has been difficult to extend to such liquid cell imaging. As a result of this advance it permits the application of multiprobe atomic force microscopes in liquid without optical interference. The invention also embodies methods that allow for multiprobe operation in liquid where optical interference is not an issue.

2. Description of the Background Art

Biological atomic force microscopes (AFM) and scanned probe microscope (SPM) devices are today seriously limited by geometric and optical obstruction and/or optical or other interference. Thus, BioAFMs cannot be integrated into upright microscopes or advanced concepts in optical microscopy such as 4pi configurations or many non-linear optical protocols. In addition, studying samples such as single molecules on opaque substrates or simultaneously investigating optically and with AFM, highly scattering samples such as biological tissue have been impossible. Furthermore, all BioAFM/SPMs today suffer from optical interference from the feedback mechanism used. In addition no BioAFM/SPM has the ability to use from above water immersion objectives. Many of these limitations prevent BioAFM/SPMs to be incorporated for example into standard upright microscope geometries often used in spectroscopic techniques such as Raman. This prevents obtaining spectroscopic techniques to obtain data at the same side of a scattering sample as the scanned probe microscopy data is being obtained.

Previous literature relating to this invention is the use of tuning forks as a non-optical feedback mechanism. In general when tuning forks are used they are not used in aqueous media and so this limits such approaches to non-biological applications.

There are a few examples of approaches to the use of tuning fork feedback in AFMs that work in liquid. One such approach only limits the application to non-aqueous liquids [Kageshima et al, “Noncontact Atomic Force Microscopy in Liquid Environment with Quartz Tuning Fork and Carbon Nanotube Probe,” Applied Surface Science 188, 440 (2002)]. The difficulty of using a tuning fork in aqueous liquids is illustrated by the work of [Koopman et al, “Shear Force Imaging of Soft Samples in Liquid Using a Diving Bell Concept,” Applied Physics Letters 83, 5083 (2003)] where ultimate efforts are taken to prevent the tuning fork from entering the aqueous solution using a diving bell mechanism. Other workers have also prevented the tuning fork from entering the liquid medium by limiting the use of the probe to a straight probe [Höppener et al, “High-Resolution Near-Field Optical Imaging of Single Nuclear Pore Complexes under Physiological Conditions,” Biophysical Journal 88, 3681 (2005)].

A critical factor in the above limitations is that all BioAFM/SPMs use the same beam bounce laser feedback mechanism which causes serious geometric constraints. In spite of the realization of this limitation it has been impossible to resolve the problem of employing a non-optical method of feedback using either a straight or cantilevered probe that could work in air or in a liquid medium without regard to the nature of the medium or to device an optical technique that would resolve some of the problems noted above. Also there is no example of a cantilevered probe being used with the tuning fork in or out of the liquid medium and being able to image sample in a liquid medium.

Also there are no examples of the ability to use a liquid immersion objective from above while the sample under the liquid medium is also being imaged from above by a scanned probe microscope probe.

Also there are no examples of using multiple independent AFM probes in either an air or liquid medium.

### SUMMARY OF THE INVENTION

The present invention is a method and a device for permitting scanned probe microscopes with a non-optical feedback mechanism to be used in air or in liquid. There are many embodiments of this objective which require both geometric construction of the scanning device that can incorporate the non-optical feedback mechanism in a way that does not obstruct geometrically essentially any lens from above or below and permits free access to the probe that is interacting with the sample. In one such embodiment, a scanner in x, y and z can move the probe with a structure in which either the non-optical feedback mechanism is in the liquid or in the air and can use either a cantilevered or straight probe. The system has the ability to work with a liquid or water immersion objective from above. This system can also be used with a variety of cantilevered probes with the tuning fork out of the liquid or partially in or out of the liquid. The system can be constructed with an x, y and z sample scanner or with multiple independent scanned probe microscopy probes that can work in liquid and/or in air.

The system also opens up the use of many new forms of scanned probe microscopy with new functional capabilities such as structurally correlated with AFM patch clamping, scanning electrochemical microscopy with new opportunities for optical integration, chemical deposition in and out of liquids with new opportunities for optical integration etc.

### BRIEF DESCRIPTION OF THE DRAWINGS

The foregoing, and additional objects, features and advantages of the present invention will become apparent to those of skill in the art from the following detailed description of a preferred and various embodiments thereof, taken with the accompanying drawings, which are briefly described as follows.

FIG. 1 is a diagrammatic view of a system that incorporates the methodologies of the subject invention.

FIG. 2 is another diagrammatic view of a system that incorporates the methodologies of the subject invention. In this view the tuning fork is out of the liquid but the cantilevered probe is totally immersed in the liquid and a liquid immersion lens 2.2 can be used above it.

FIG. 3 illustrates a system built according to one embodiment of the present invention in which an x, y and z scanner 3.1 holds a probe 3.2 which is totally immersed in this case in water with the tuning fork feedback mechanism and a water immersion lens 3.3 is capable of viewing the sample from the same side as the lens. In this case there is also an x, y and z sample scanner 3.4 and the figure shows that any of a variety of containers can be used for the holding the liquid 3.5 with and without environmental control.

FIG. 4 illustrates another embodiment of a tuning fork probe. In this probe the tuning fork 4.1 can be kept out of liquid and can still use cantilevered probes 4.2. Although the tuning fork in this embodiment is perpendicular to the surface of the sample in this embodiment and in all other embodiments the tuning fork can be at any angle relative to the sample including parallel to the sample.

FIG. 5 illustrates a multiple probe system incorporating two probes 5.1 and 5.2 which can work with the embodiments of the subject invention disclosed herein to provide air or liquid operation. Although two probes are shown more than two independently operated scanned probe microscopy probes can be incorporated. Also in this system the sample can also be moved with an x, y and z scanner 5.3 while the non-optical feedback keeps the probe imaging in liquid.

FIG. 6 illustrates a method that allows for multiple probe operation with or without liquid immersion objectives 6.1 from the same side as the scanned probe microscopy probe. Such a method can accomplish multiple probe operation in liquid that has never been achieved before the formation of the subject invention. In this embodiment the method includes a laser 6.2 and a detector 6.3 however the exact position of the detector or the exact optical method be it beam bounce, obstruction (as shown) or interference are all capable of multiple probe operation. The method however does not achieve non-optical feedback for multiple probes which is part of the other embodiments described herein.

### DETAILED DESCRIPTION OF THE PREFERRED EMBODIMENTS

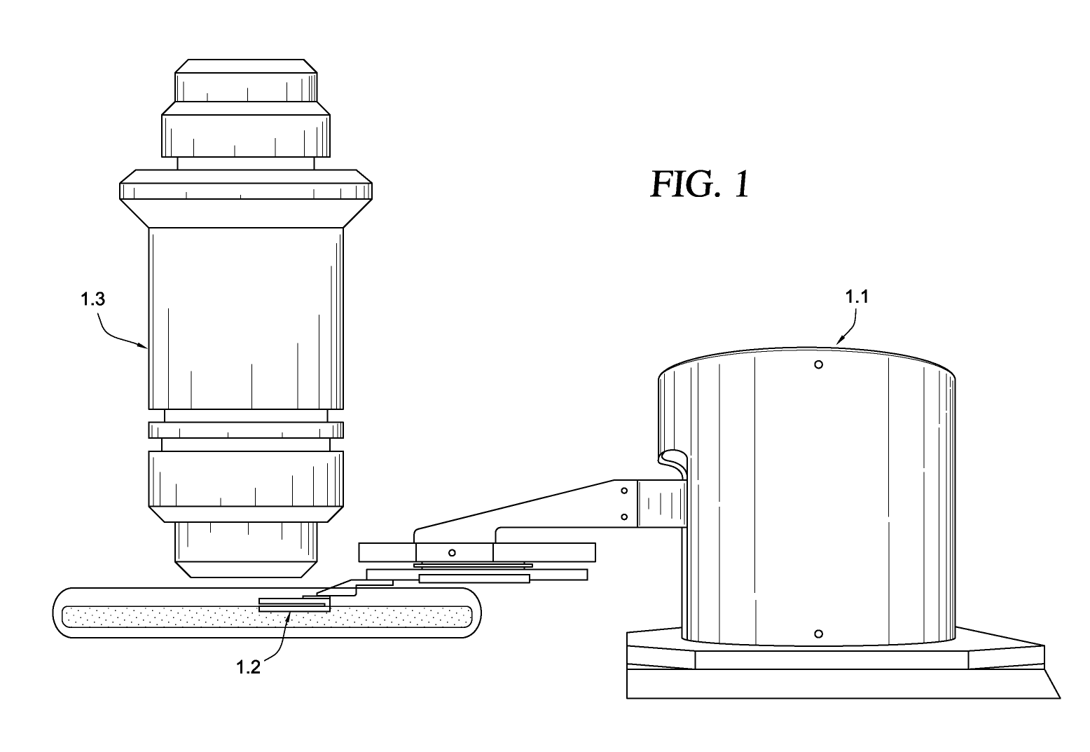

A diagrammatic representation of a system that implements a first preferred embodiment of the subject invention is shown in FIG. 1. In this representation 1.1 is the scanner that holds the non-optical method of feedback comprising a tuning fork 1.2. In this diagrammatic representation a lens 1.3 is shown and the tuning fork is partially in the liquid but not fully in the liquid. In fact the tuning fork can be in air or fully in the liquid or partially in the liquid and can be at any angle relative to the sample the angle chosen based on whether normal or shear force is employed for the feedback signal.

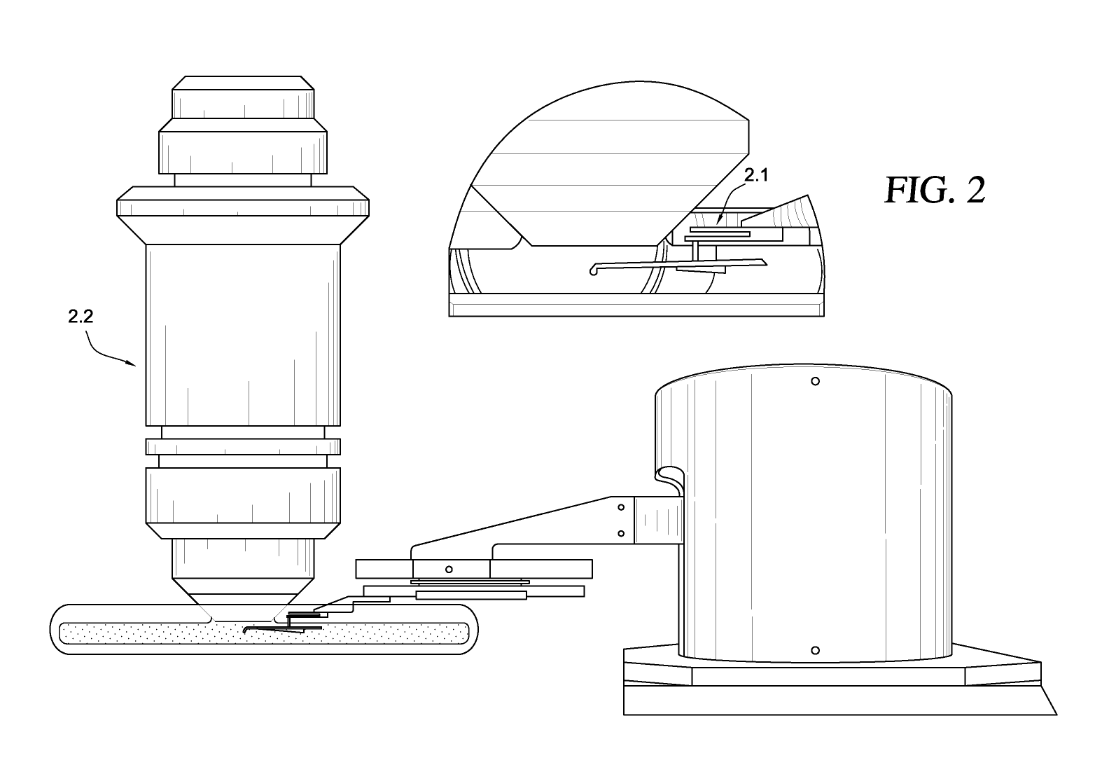

Another diagrammatic view of a system that incorporates the methodologies of the subject invention is shown in FIG. 2. In this view the tuning fork 2.1 is out of the liquid but the cantilevered probe is totally immersed in the liquid and a water immersion lens 2.2 is used. Again it is noted that the tuning fork can be at any angle relative to the sample the angle chosen based on whether normal or shear force is employed for the feedback signal.

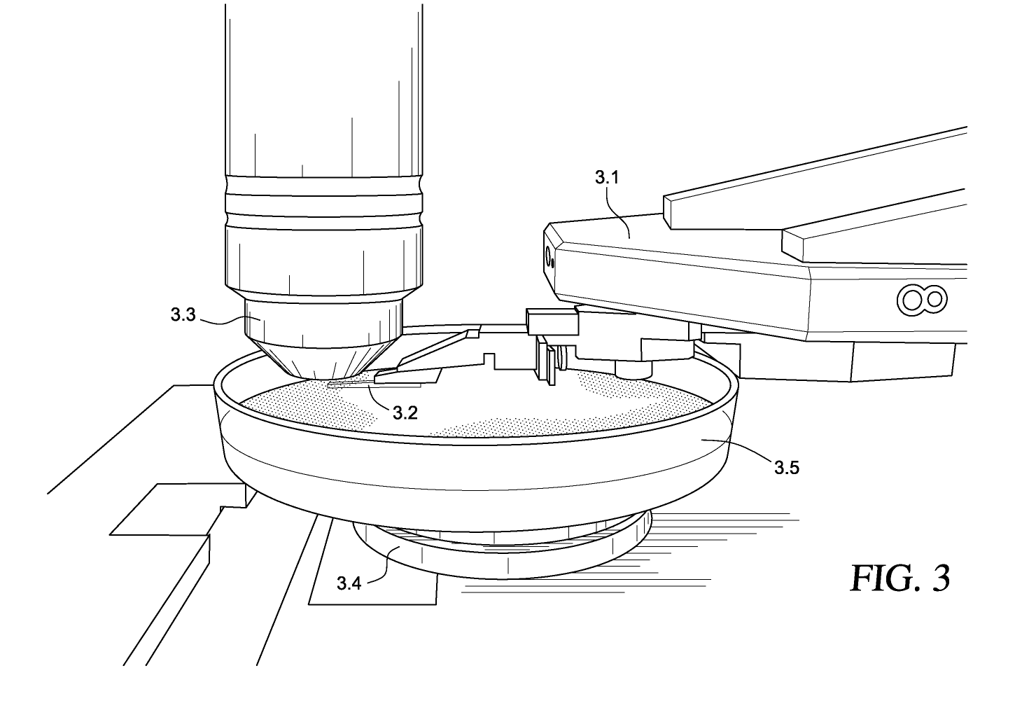

An actual system using one embodiment of the invention is shown in FIG. 3 in which an x, y and z scanner 3.1 which holds a probe 3.2 which is totally immersed in this case in liquid with the tuning fork feedback mechanism and a water immersion lens 3.3 is capable of viewing the sample from the same side as the lens. In this case there is also an x, y and z sample scanner 3.4 and the figure shows that any of a variety of containers can be used for the holding the liquid 3.5. These containers can be used with or without environmental control.

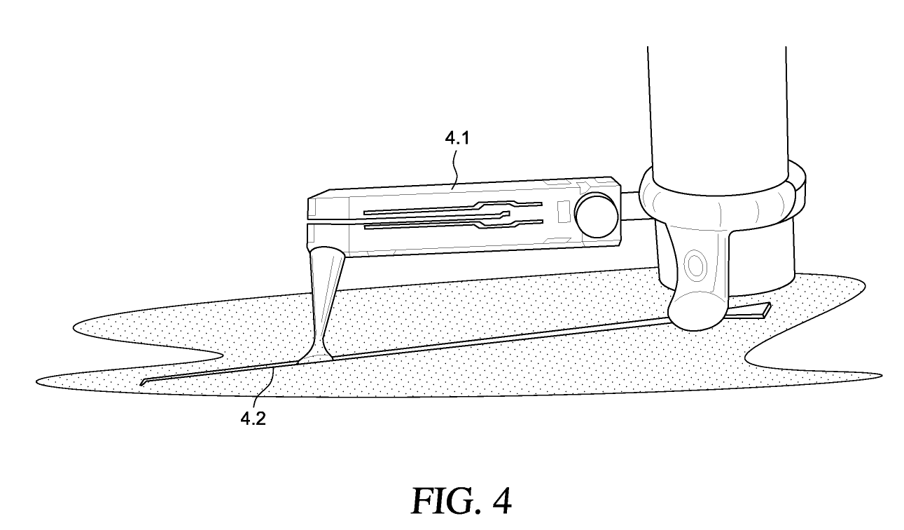

Another embodiment of a non-optical feedback with a probe is shown in FIG. 4. In this the probe with the tuning fork 4.1 can be kept out of liquid and can still use cantilevered probes 4.2. Although in these cases glass probes are shown it should be realized that any probe for scanned probe imaging functional or otherwise or alteration or manipulation can be used with this or any other non-optical or optical feedback that is part of the subject invention.

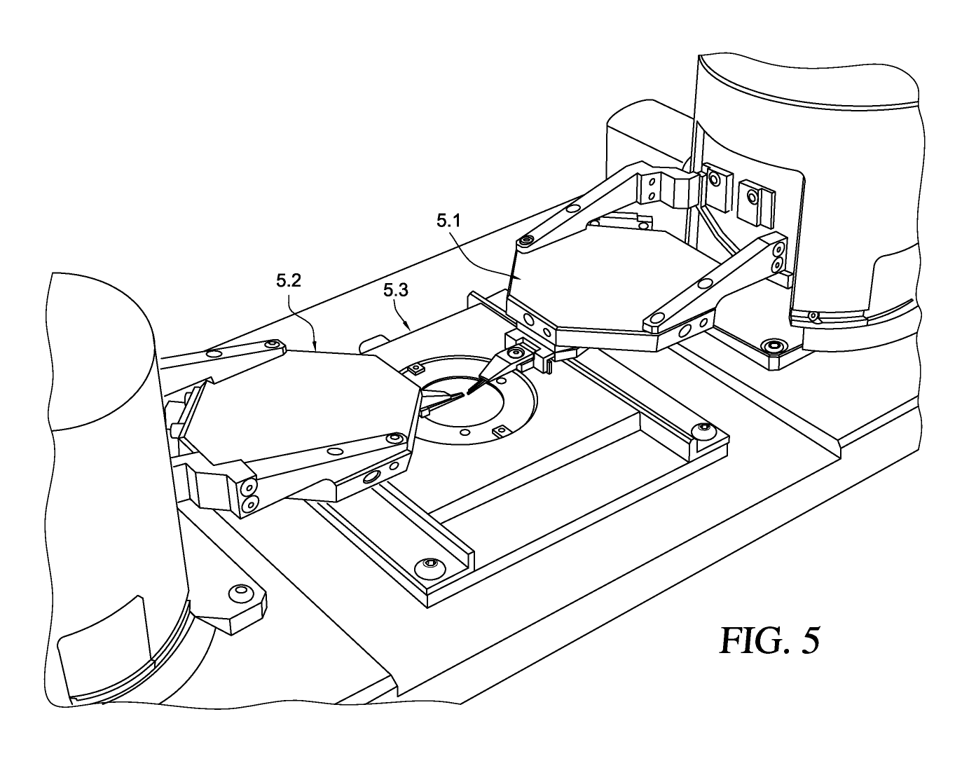

A multiple probe system incorporating two probes 5.1 and 5.2 which can work with the embodiments of the subject invention to provide air or liquid operation is illustrated in FIG. 5. Although two probes are shown more than two independently operated scanned probe microscopy probes can be incorporated. Also in this system the sample can also be moved with an x, y and z scanner 5.3 while the non-optical feedback keeps the probe imaging in liquid.

In some embodiments of this invention the tuning fork is coated with a material that is not conductive and has little perturbation on the mechanical properties of the tuning fork. There are numerous ways to accomplish this; some involve deposition of a thin film of organic material that prevents electrical interference in such media as aqueous media. However also dipping procedures and other methods can be used to coat the tuning fork or other non-optical device and the method that is used does not change one of the important concepts of this invention to accomplish a non-optical method such as a tuning fork for working in liquid or air.

Also it should be realized that there are many other possible methods other than tuning forks for providing the goals of the subject invention. One such example is piezo cantilever devices which can be coated as above. There are also many more examples in the same vein.

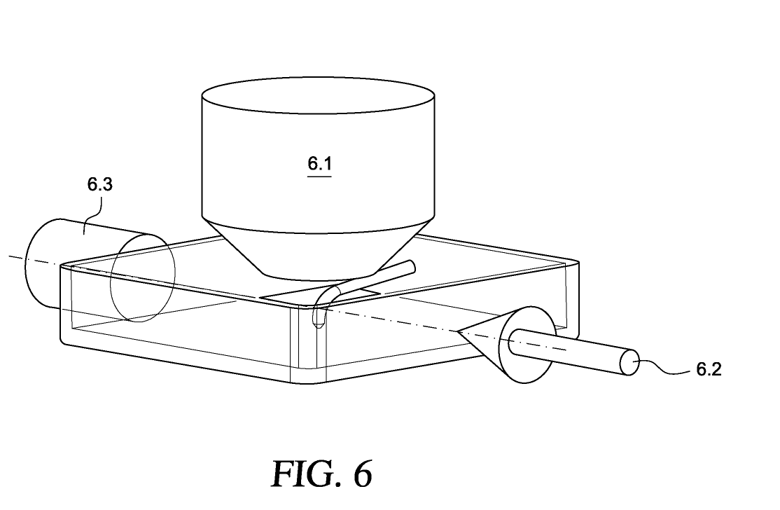

Furthermore, multiple probe operation in liquid has never been accomplished either with optical or non-optical feedback. Non-optical feedback that can now work in any liquid clearly permits this. However, if the non-optical feedback is relaxed then the present invention also includes such methodologies as described in FIG. 6.

In FIG. 6 an optical method that allows for multiple probe operation is shown with or without liquid immersion objectives 6.1, from the same side as the scanned probe microscopy probe. In this embodiment the method includes a laser 6.2 and a detector 6.3 however various positions of the detector or various optical methods, be it beam bounce, obstruction (as shown) or interference are all capable of multiple probe operation. The method however does not achieve non-optical feedback for multiple probes which is part of the other embodiments described herein but certainly achieves other objectives of the subject invention and can use all probes such as those for patch clamping or conductance or scanning electrochemical microscopy or electrical or thermal conductivity or chemical delivery and writing or nano vacuum etc. All of this is also capable of being integrated with the other methodologies of the subject invention.

All of the above methods can be used for force spectroscopy and those embodiments of this invention that allow for phase feedback with or without phase locked loops can provide for exceptional sensitivity in such force spectroscopy applications with single or multiple probe operation.

Also the ability to have a lens from above at the same side as the probe permits combination of force spectroscopy that were difficult to impossible to achieve in the past such as combination with Raman spectroscopy or non-linear optical techniques which are now all possible with the embodiments of the invention described herein.

1. A device for scanned probe microscopy that is based on a non-optical form of feedback that allows for operation in liquid or air or partially in both with any types of probes including those that are cantilevered or straight.

2. A device as in claim 1 that can operate with the appropriate probes without interference from above or below.

3. A device as in claim 1 that can operate with or without a liquid immersion objective from the same side as the probe is probing the sample.

4. A device as in claim 1 that can provide for single probe or multiple probe operation.

5. A device as in claim 4 that can use coated or uncoated tuning forks or other non-optical sensing mechanisms.

6. A device as in claim 5 that can configure new probes on the same non-optical feedback device.

7. A device as in claim 5 in which any orientation of the non-optical feedback device is possible including any angle for the tuning fork for normal or shear force operation.

8. A device as in claim 5 that can be integrated into any optical microscope.

9. A device as in claim 8 that can achieve ultrasensitive force spectroscopy with phase feedback.

10. A device as in claim 8 that can achieve ultrasensitive force spectroscopy together with such spectroscopic techniques as Raman spectroscopy or non-linear optical methods.

11. A device as in claim 9 that can achieve ultrasensitive force spectroscopy together with such spectroscopic techniques as Raman spectroscopy or non-linear optical methods.

12. A device as in claim 4 that can be integrated with patch clamping or conductance or electrical or scanning electrical chemical microscopy or thermal conductivity or chemical deposition or nano vacuum.

13. A device for scanned probe microscopy that that allows for operation of probes in liquid or air or partially in both that can permit multiple probe operation with optical feedback.

14. A device as in claim 13 that can use a liquid immersion objective from the same side as the probe is probing the sample.

15. A device as in claim 13 that can use cantilevered or straight probes.

16. A device as in claim 15 that can achieve ultrasensitive force spectroscopy together with such spectroscopic techniques as Raman spectroscopy or non-linear optical methods.

17. A device as in claim 15 that can achieve ultrasensitive force spectroscopy with phase feedback.

18. A device as in claim 13 that can be integrated into any optical microscope.

19. A device as in claim 18 that can be integrated with patch clamping or conductance or electrical or scanning electrical chemical microscopy or thermal conductivity or chemical deposition or nano vacuum.

20-38. (canceled)
